(19) United States
(12) Patent Application Publication
(10) Pub. No.: US 2006/0294248 A1
(43) Pub. Date: Dec. 28, 2006

(54) Automatic server configuration based on user agent

(75) Inventor: Daniel J. Kershaw, Kirkland, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/168,957

(22) Filed: Jun. 28, 2005

(51) Int. Cl. G06F 15/16

(52) U.S. Cl. 709/228

(57) ABSTRACT

A communications server is provided that is able to receive a Session Initiation Protocol (SIP) message, and access SIP client-specific information within the SIP message. The client specific information can be provided in a user agent header. The server automatically adapts its interaction with the SIP client based on the client-specific information. A method of automatically configuring a communications server is also provided.

### BACKGROUND

Real-time communications can take many forms, such as voice and video communication, instant messaging, application sharing and collaboration. In the process of transmitting real-time communications from one point to another, multiple steps are involved and various protocols are used. First, some type of signaling and call control is needed to establish, modify, and terminate a call. Within the public switched telephone network (PSTN), a circuit-switched network, Signaling System 7 (SS7) is used for call setup and termination. For packet-based networks, both the SIP and H.323 protocols provide call control.

After the calling session is established, the audio or video input needs to be sampled and converted to a digital format. Next, the sampled data is encapsulated into Real-time Transport Protocol (RTP) packets. RTP is specifically designed for the needs of real-time communication over a packet-based network.

Then, the RTP packet is encapsulated into a network transport protocol, which is most often the User Datagram Protocol (UDP). Alternatively, the Transmission Control Protocol (TCP) can be used for encapsulation; however, because TCP is a guaranteed transport-level protocol, the additional time needed to occasionally retransmit TCP packets can add enough latency (the time between sending and receiving packets) to the transmission so that the received audio is unintelligible. Throughout the transmission of the RTP packets, the Real-time Control Protocol (RTCP) is used to monitor the quality of an RTP session.

Next, the network transport protocol, UDP or TCP, is encapsulated into an IP packet, which is then encapsulated into the link layer protocol—Ethernet, for example. The link layer packet is then transmitted to the destination computer(s).

Session Initiation Protocol (SIP), which is similar to the HyperText Transfer Protocol (HTTP), is a text-based application-layer signaling and call control protocol. SIP is used to create, modify, and terminate SIP sessions. It supports both unicast and multicast communication. Because SIP is text-based, implementation, development, and debugging are easier than with H.323.

The main components of a SIP environment fall into two primary categories, SIP servers and SIP user agents.

There are three types of SIP servers: proxy, registrar, and redirect. Each type of server performs a different function, as noted in below. The specific function the server performs determines which SIP requests it processes.

A proxy server acts as an intermediary between a SIP user agent client and a SIP user agent server. The proxy server performs the functions of either a SIP user agent client or a SIP user agent server, depending upon the direction of the communication between the client and server. A proxy server can simply forward the SIP request or modify it before sending it on.

A registrar server receives REGISTER requests, which contain both the IP address and the SIP address—the Uniform Resource Locator (URL)—of the user agent. This allows the registrar server to keep track of the location of user agents from which the registrar server has received REGISTER requests.

A redirect server accepts initiation, in the form of a SIP INVITE request, of a SIP session for the calling user agent, obtains the correct SIP address of the called user agent, and replies to the calling user agent with the correct SIP address. The calling user agent then uses the correct SIP address to directly initiate a SIP session with the called user agent.

SIP servers —proxy, registrar, and redirect —can be developed as separate applications or as a single application combining the functionality of all the servers. The combination of a registrar and proxy server is sometimes referred to as a rendezvous server.

There are two types of SIP user agents and their functions are set forth below. A user agent client initiates SIP requests, while a user agent server receives SIP requests. Each user agent is associated with a SIP address.

The call flow for SIP sessions depends upon whether the SIP session is established directly between SIP user agents or whether a SIP server (proxy, registrar, or redirect) is located between SIP user agents. Typical call flow between two user agents generally occurs as follows. First, a user agent, such ias user agent A, sends out an INVITE request to initiate a call. Another user agent, such as user agent B, then replies with the Trying response code (100), indicating that the call request is being processed. User agent B then replies with the OK response code (200), indicating that that user agent has accepted the call. User agent A then replies to user agent B with an acknowledgement (ACK) request, indicating that user agent A received the final response code from user agent B. The real-time data is then encapsulated in RTP packets and sent between user agent A and user agent B. Either user agent A or user agent B can then send a BYE request, indicating the that the user agent wants to terminate the session. User agent B then sends an OK response code (200) to user agent A to indicate that the request has succeeded.

SIP messages are based on the standard Internet message format, as described in RFC 822, “Standard for the Format of ARPA Internet Text Messages.” Each SIP message has three parts: a start line; headers and a message body.

“Start line” Contents depend on whether the message is a request or a response. Both request and response start lines include the SIP version. Request start lines also include the method type and the SIP address or general URL of the destination receiving the request. Response start lines also include the numeric start-code and reason-phrase that define the response to the request.

“Headers” contain the header type and associated variable(s).

“Message body” contains information provided by the Session Description Protocol (SDP), such as the description of the media capabilities of the SIP session. SIP defines the values for the start line and headers. The Session Description Protocol (SDP) defines the values for the message body.

The start line of a SIP message is followed by one or more headers. The included headers depend upon whether the message is a response or a request. Headers are defined in RFC 3261, “SIP: Session Initiation Protocol,” which can be found at http://www.microsoft.com/windows/reskits/websources/.

Headers fall into one of four categories: general, request, response, and entity. Headers in the general category can be used for both request and response messages.

General headers include Accept; Accept-encording; Accept-language; Call-ID; Contact; Cseq; Date; Encryption; Expires; From; Record-route; Time stamp; To and Via.

Request headers include Authorization; Contact; Hide; Max-forwards; Organization; Priority; Proxy-authorization; Proxy-require; Route; Require; Response-key; Subject and User-agent.

Response headers include Allow; Proxy-authenticate; Retry-after; Server; Unsupported; Warning and WWW-authenticate.

Entity headers include Content-encoding; Content-length and Content-type.

### SUMMARY

A communications server is provided that is able to receive a Session Initiation Protocol (SIP) message, and access SIP client-specific information within the SIP message. The client specific information can be provided in a user agent header. The server automatically adapts its interaction with the SIP client based on the client-specific information. A method of automatically configuring a communications server is also provided.

### BRIEF DESCRIPTION OF THE DRAWINGS

FIG. 1 is a block diagram of one computing environment in which the present invention may be practiced.

FIG. 2 is a diagrammatic view of a sample SIP architecture within which embodiments of the present invention are particularly useful.

FIG. 3 is a diagrammatic view of a communications server interacting with SIP clients in accordance with one embodiment of the present invention.

FIG. 4 is a flow diagram of a method of configuring a communications server in accordance with an embodiment of the present invention.

### DETAILED DESCRIPTION OF ILLUSTRATIVE EMBODIMENTS

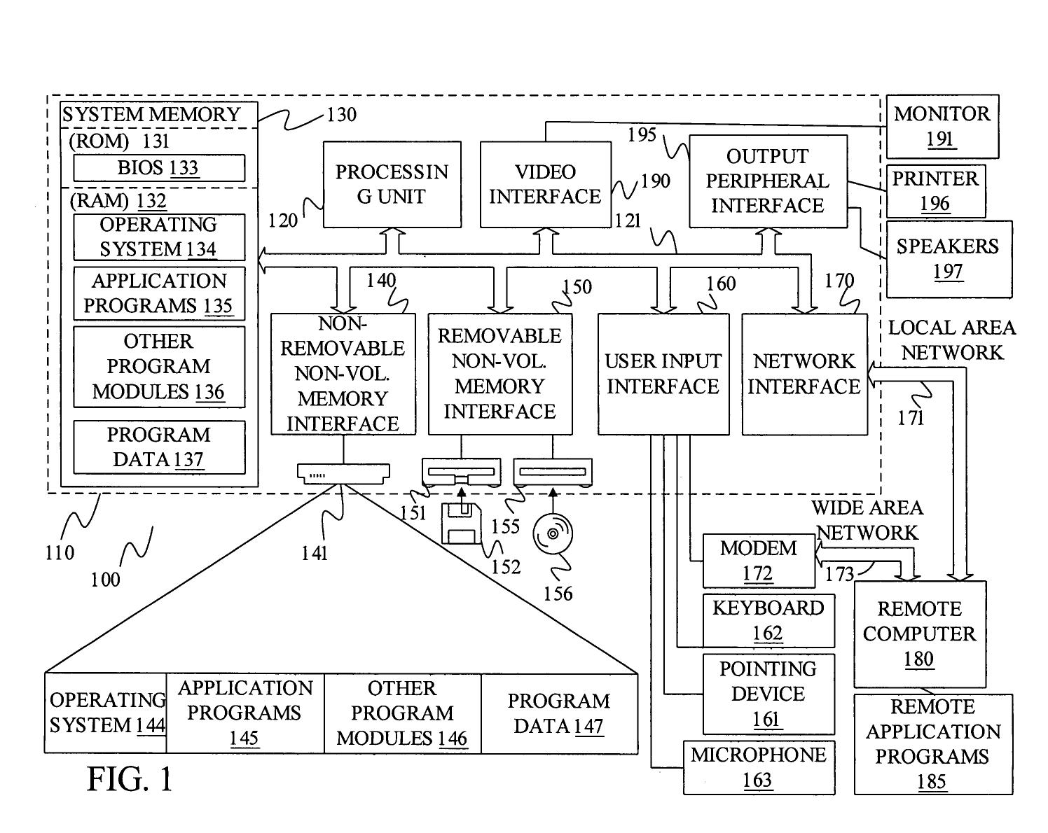

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention is designed to be practiced in distributed computing environments where tasks are performed by remote processing devices that are linked through a communications network. In a distributed computing environment, program modules are located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 is operated in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

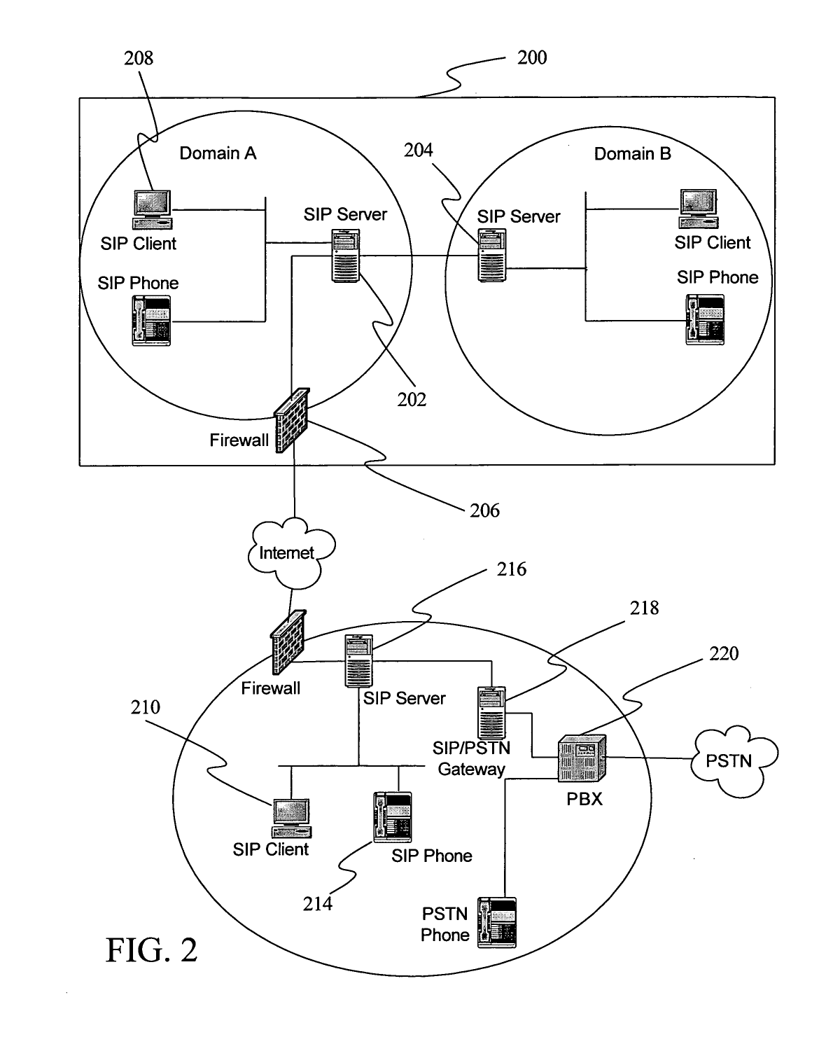

FIG. 2 is a diagrammatic view of a sample SIP architecture within which embodiments of the present invention are particularly useful. Each of the servers illustrated in FIG. 2 may be comprised of any suitable computing device, including that described above with respect to FIG. 1. FIG. 2 illustrates one exemplary way that real-time communication can be performed. Enterprise 200 includes proxy servers 202, 204 that direct SIP requests between domains A and B within enterprise 200. Proxy server 202 is coupled to firewall 206 and handles all SIP messages sent to recipients outside enterprise 200. For example, a SIP INVITE message sent from SIP client 208 would be sent via proxy server 202.

Proxy server 202 then forwards the SIP INVITE request from client 208 to the destination SIP client computer 210 or SIP IP phone 214 in the domain of proxy server 216 within enterprise 212. For example, server 216 might receive a SIP INVITE request sent with a SIP URL in the format of a global telephone number. If the global telephone number has a destination of a SIP phone within enterprise 212, then the SIP INVITE request will be forwarded directly to the appropriate SIP phone within enterprise 212. On the other hand, if the global phone number has a destination of a non-SIP IP phone, such as an analog phone, then the SIP INVITE request will be forwarded to SIP/PSTN gateway 218, which formats the SIP INVITE request for the PSTN. Using the global phone number, the enterprise's private branch exchange (PBX) 220 determines whether to route the call to an analog phone within enterprise 212, or to route it to the PSTN for an analog phone outside enterprise 212.

Given the different types of real-time communications, communication devices, and protocols, it is sometimes possible that two different manufacturers will implement a given function differently. For example, in telephony, calls can be forwarded or redirected. In ISDN systems, the ISDN will carry the call redirection information. This information includes the number of times that the call has been forwarded as well as the originating phone number. Currently, there are at least two manufacturers who provide this information through SIP in different ways. A first manufacturer uses a header called the “history-info” header, while the second manufacturer uses the “diversion” header. Both manufacturers are providing the same call redirection information, but in different ways. This is simply one example of how one function is implemented differently by two different manufacturers. With the wide ranging applications for real-time communication, there are doubtless many other examples of such differences. If not properly understood and dealt with, these differences can give rise to fundamental incompatibilities in real-time communications.

In accordance with one broad aspect of embodiments of the present invention, generally provide client-specific information in a user-agent header field. A communications server then parses the SIP message to read the contents of the user-agent field, such that the server can adapt or modify its interaction with the SIP client.

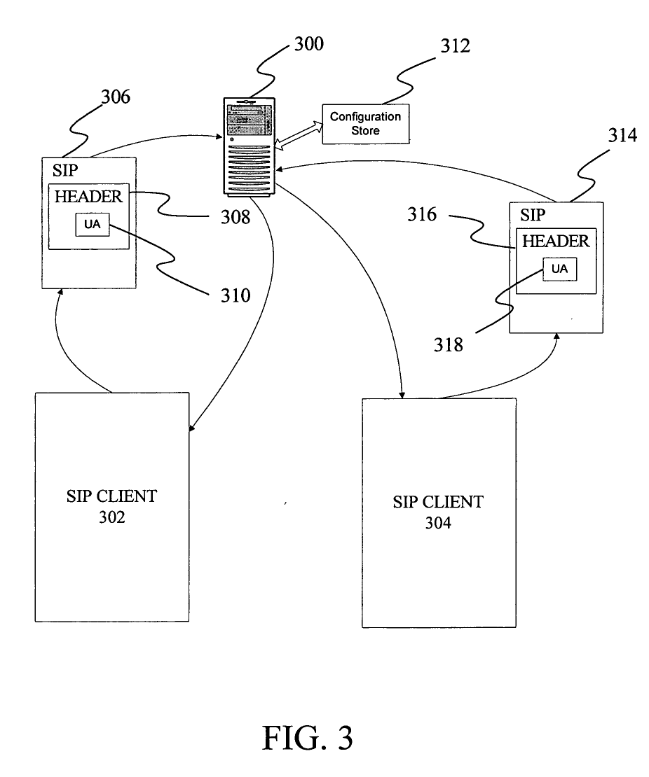

FIG. 3 is a diagrammatic view of a communications server interacting with SIP clients in accordance with one embodiment of the present invention. Communications server 300 can be implemented on any suitable computing platform, including that described above with respect to FIG. 1. Server 300 can provide any of the communications server functions listed above, including proxy server, registrar server, redirect server, or any combination thereof. Server 300 is communicatively coupled to SIP clients 302 and 304. For the sake of illustration, each of clients 302 and 304 provide identical communication functions, but do so in different ways.

SIP client 302 issues a SIP message containing user agent header containing information 310 indicative of at least one characteristic of SIP client 302. Preferably, information 310 indicates the manufacturer of SIP client 302. However, information 310 can also include any suitable additional information. Server 300 reads the information 310 within header 308. Server 300 then adapts its communication with SIP client 302 based on information 310. In one embodiment, server 300 may use the manufacturer information preferably present in information 310 to access a configuration store 312 to obtain specification(s) for interacting with SIP client 302. Server 300 then adapts its interaction with SIP client 302 based upon the specification information obtained from store 312. Configuration store 312 may be a data store within server 300, or a remote source of data coupled to server 300.

Like SIP client 302, SIP client 304 also issues a SIP message to server 300. SIP message 314 includes user agent header 316 containing information 318 indicative of at least one characteristic of SIP client 304. Preferably, information 318 indicates the manufacturer of SIP client 304. However, information 318 can also include any suitable additional information. Server 300 reads the information 318 within header 316. By reading information 318, server 300 can adapt its communication to be suitable for interaction with SIP client 304. Thus, although SIP clients 302 and 304 may act differently to implement similar functions, as long as server 300 can identify clients 302 and 304, it can interact with each client in a client-specific manner. This allows greater flexibility for the user and implementation of server 300 since it is better able to interact with systems from various manufacturers. Moreover, as standards change over time, server 300 can employ embodiments of the present invention to interact with difference versions of SIP clients just as if they were from different manufacturers. Finally, as new methods and techniques for real-time communication are developed, server 300 can be adapted to interact with new devices and clients simply by updating information stored in configuration store 312.

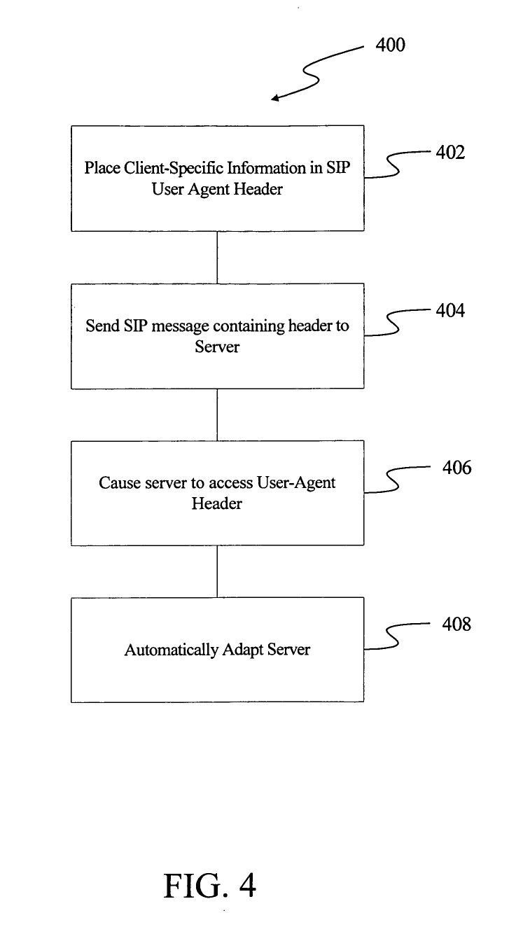

FIG. 4 is a flow diagram of a method of configuring a communications server in accordance with an embodiment of the present invention. Method 400 begins at block 402 where a SIP client places at least some information about itself in a user-agent header of a SIP message. At block 404, the SIP client transmits the SIP message containing the header to a communications server. At block 406, the communications server accesses the user-agent header and obtains the client specific information stored during block 402. Optionally, the communications server can use the client-specific information to retrieve additional client-specific information. For example, if the client specific information is simply an indication of the manufacturer of the SIP client, the server can perform a query, or otherwise look up further information regarding interactions with that manufacturer's client. Moreover, embodiments of the present invention also include the situation where the communications server fails to find any additional information relative to the SIP client, and instead uses a default interaction mode. Preferably, this default interaction mode is described in a document that SIP client manufacturers can access such that their clients can be built to interact at least in accordance with the default mode. At block 408, the server adapts its interaction with the SIP client based on the information that it accessed in the received user-agent header. Examples of such adaptation include using a restricted set of communication protocols, and/or placing certain messaging information is selected SIP headers.

Embodiments of the present invention provide a communications server with the ability to better interact with a wider range of SIP clients. It is believed that such interactions will facilitate wider adoption of packet-based real-time communication without requiring SIP manufacturers to incur significant additional design costs. Further, by better understanding the nature of SIP clients, it is possible that more efficient interactions between such clients and one or more communications servers can be achieved.

Although the present invention has been described with reference to particular embodiments, workers skilled in the art will recognize that changes may be made in form and detail without departing from the spirit and scope of the invention.

What is claimed is:

1. A communications server comprising:
an interface configured to receive a session initiation protocol (SIP) message, the SIP message containing SIP client-specific information;
a processing unit operably coupled to the interface, the processing unit being configured to communicate with the SIP client through the interface; and
wherein the processor is configured to adapt its communication with the SIP client based at least in part on the SIP client-specific information.

2. The server of claim 1, and further comprising a configuration store operably coupled to the processing unit.

3. The server of claim 2, wherein the processor is configured to query the configuration store based on the client-specific information to obtain additional client specific information.

4. The server of claim 3, wherein the processor is adapted to use a default interaction with the SIP client upon failure of the query.

5. The server of claim 2, wherein the configuration store is part of the server.

6. The server of claim 2, wherein the configuration store is remote from the server.

7. The server of claim 1, wherein the client specific information includes a manufacturer of a SIP client.

8. The server of claim 1, wherein the client specific information includes a version of the SIP client.

9. The server of claim 8, wherein the client specific information further includes a manufacturer of the SIP client.

10. The server of claim 1, wherein the client-specific information is provided in a user agent header.

11. The server of claim 10, wherein the client specific information includes a manufacturer of a SIP client.

12. The server of claim 10, wherein the client specific information includes a version of the SIP client.

13. The server of claim 12, wherein the client specific information further includes a manufacturer of the SIP client.

14. A computer-implemented method for automatically configuring a communications server, the method comprising:
receiving a session initiation protocol (SIP) message;
accessing SIP client-specific information contained in the SIP message; and
automatically adapting at least one interaction between the server and a SIP client based on the client-specific information.

15. The method of claim 14, wherein the SIP client-specific information is provided in a user agent header.

16. The method of claim 14, and further comprising querying a configuration store based on the client-specific information.

17. The method of claim 16, and further comprising employing a default interaction with the SIP client upon failure of the query.

18. The method of claim 14, wherein the client-specific information includes an indication of a manufacturer of a SIP client.

19. The method of claim 14, wherein the client-specific information includes an indication of a. version of a SIP client.

20. A method for establishing real-time packet-based communication the method comprising:
steps for receiving a SIP message containing SIP client-specific information;
steps for reading the client-specific information within the SIP message; and
steps for adapting a communications server based on the client-specific information.
